(19) United States
(12) Patent Application Publication
(10) Pub. No.: US 2013/0110635 A1
(43) Pub. Date: May 2, 2013

(54) SMS Transaction Initiated by Vendor Offer

(71) Applicants: Jeffrey C. Clift, Melbourne, FL (US); Ronald J. Peri, Windermere, FL (US)

(72) Inventors: Jeffrey C. Clift, Melbourne, FL (US); Ronald J. Peri, Windermere, FL (US)

(21) Appl. No.: 13/284,896

(22) Filed: Oct. 29, 2011

(51) Int. Cl. G06Q 30/02; H04W 4/14

(52) U.S. Cl. 705/14.64

(57) ABSTRACT

A method and system for completing a transaction for sale of an item using only text/SMS messaging, including establishment of form of payment. Using a standard message presenting the initial offer and continuing with a prescribed dialogue allows transactions to be fully executed using only SMS messages. Incorporating predefined messages for acquiring help and creating payments to be associated with an individual are key elements of the system. In addition, social media that rely on SMS/text messaging, such as Twitter, can be readily accommodated using this method.

### BACKGROUND OF THE INVENTION

The invention relates generally to a system and method for offering and completing the sale of items using SMS messaging. In particular, this method requires no additional media connection or third party application to complete the sale.

### DESCRIPTION OF THE RELATED ART

Cell phones and PDAs have become commonplace devices as users have become dependent on technology to keep them connected and up to date regarding the world around them. As the requirement for mobile applications continues to increase, there is an increasing need for efficient means to offer items for sale to customers using these devices, however, not all customers have access to or desire to use web based applications on this medium. Some applications, most notably Twitter, rely on a basic 140 character message for all communications and do not allow exceptions. Many mobile devices do not handle more sophisticated communication schemes very well or in many cases, the communications providers charge a significant fee for access to these mechanisms.

There are many schemes today that utilize simple text or SMS messaging to broadcast offers to customers, but these typically require the recipient to access a web site or call a toll-free number to take advantage of the offer.

What is needed is a mechanism by which a targeted customer can receive a short message (text or SMS message) and reply to that message in order to take advantage of the offer and complete the transaction. For ease of convenience and efficiency, it is important for the message recipient to be able to perform all operations required to complete the transaction, including payment if necessary, without requiring access via another medium, such as a web site or telephone call.

U.S. Pat. No. 7,716,109 typifies the typical type of online transaction process which utilizes a web based interface to complete all aspects of the transaction. U.S. Pat. No. 7,496,527 identifies a partial transaction process, but does not allow for the transaction to be completed without appearing in person to finalize the transaction. U.S. Pat. No. 7,318,098 describes a system using a surrogate and an online database, but these are typical applications that cannot complete a transaction without involving secondary applications.

U.S. Pat. No. 7,945,240 describes a payment transaction method, but this simply defines a notification of a billing notification message and notice of transfer of funds from a previously designated account. U.S. Pat. No. 6,415,156 describes a method whereby a customer orders goods from a merchant and payment is secured through a predefined transfer, however, this method covers transactions initiated by the customer, not the vendor.

Similarly, the following patents all describe some form of payment or transaction, but none provide for a response to a solicitation from a vendor and a method to complete the transaction:

U.S. Pat. No. 6,097,962

U.S. Pat. No. 6,988,657

U.S. Pat. No. 6,996,409

U.S. Pat. No. 7,011,245

U.S. Pat. No. 7,014,107

U.S. Pat. No. 7,024,174

U.S. Pat. No. 7,255,264

U.S. Pat. No. 7,340,249

U.S. Pat. No. 7,537,152

U.S. Pat. No. 7,693,797

U.S. Pat. No. 7,909,243

U.S. Pat. No. 7,917,160

U.S. Pat. No. 8,032,453

### SUMMARY OF THE INVENTION

A method and system for providing offers to potential customers and allowing them to complete a transaction without invoking any additional devices or media. The system described involves the ability to send a small message, typically referred to an SMS (Short Message Service) to interested customers and offer them the ability to respond to the solicitation and take advantage of the offer being made.

In one embodiment of the system, a message is sent to a single user or broadcast to a large population of users offering a particular item or service, such as a discounted airfare, special promo pricing on an item or service, or distressed inventory of various types. This solicitation allows the user to respond to the message using standard responding mechanisms requesting additional information, if necessary, in order to complete the transaction. In the instance of an airfare offering, the user must select the dates, origin and destination and number of seats desired. The user must provide information regarding form of payment desired. This embodiment supports a message flow that allows, through a series of exchanges, the ability to refine and select the specific item or items to be purchased. Once the items have been selected and priced, the user commits the transaction and the items are purchased.

In another embodiment, a social media application, such as Twitter, can publish an offer using the mechanisms inherent in the application. This is typically an offer posted to users who “follow” a vendor whereby they are notified that a new posting has been made and interested users can then receive this information via an SMS message. At this point, the transaction is completed using the same mechanism as described in the first embodiment described in paragraph 6.

The market for this type of system consists of vendors who desire to make special offers to interested consumers and are capable of completing transactions where the delivery of the item offered can be accommodated electronically, such as the travel industry.

### BRIEF DESCRIPTION OF THE DRAWINGS

FIG. 1 is a block diagram of a system that shows the information flow from the host system to and from the consumer. In this diagram, a typical messaging scheme is outlined showing the types of messages exchanged with the consumer. The number of messages, as well as their contents, is specific to the application and the information that needs to be conveyed. As an example, an airline booking is depicted in FIG. 2. This diagram shows sample text messages from a representative implementation. FIG. 3 depicts sample text messages that could be incorporated to register a credit card as a form of payment in an implementation desiring this capability. If payment registration is implemented, they can be registered against the SMS phone number or other identification means as desired by the application. FIG. 3 also depicts how a simple help system can be built into the dialogue to allow consumers to see the syntax of the messages.

### DETAILED DESCRIPTION

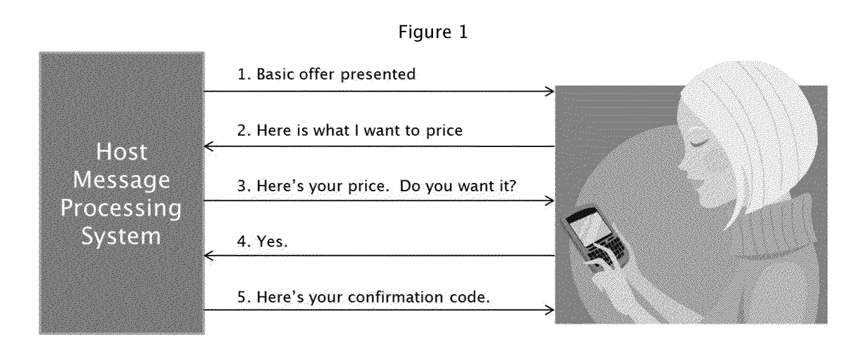

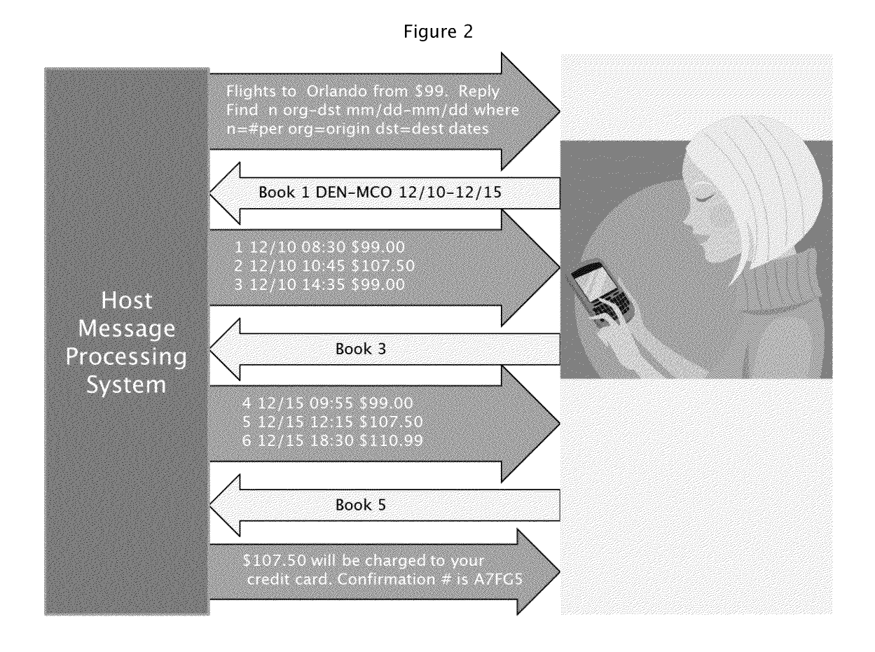

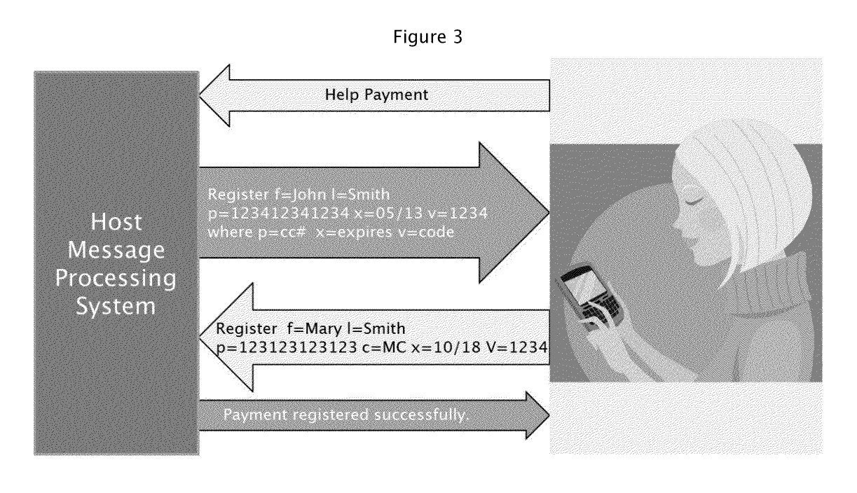

With reference to FIG. 1, a system for presenting an offer to a consumer using SMS communications and allowing them the ability to purchase the item offered using only SMS messages. FIG. 1 depicts the message dialogue between the host system and the customer to conduct a transaction that is initiated by the host system presenting an offer, allowing the customer to select from multiple options and providing a price for the selection. The user then has the ability to accept or reject the offer. If they elect to accept the offer, a confirmation is returned to the customer.

What is described is a messaging system, comprised of text messages, compatible with all SMS message types, including Twitter, that allow a transaction to take place for the purchase of an offered item. One of the keys of this approach is the ability to register a form of payment using the SMS messaging system. This form of payment is stored securely in a database that is associated with the user's ID, either their mobile telephone number or some other unique identifier, such as a Twitter ID.

The numbers of messages is not specific, nor is their content, provided in all cases, that the length of the message and the characters used are compatible with standard SMS text messaging. The dialogue required to complete the transaction consists of an offer for sale of specific or generalized items. The consumer must provide whatever specific information is required to verify that the item is available and the price that will result from the consumer's selection. If the consumer elects to purchase the item(s) then a message is sent to commit the purchase. At this time, the item is secured with the form of payment previously registered and a confirmation message is sent back to the purchaser. In the event that a customer has not registered a form of payment, they are informed of this at some point in the cycle, but when this happens can occur at any point prior to the purchase and commitment of inventory.

In the case of the airline reservation, depicted in FIG. 2, the customer must select an outbound and return flight in two messaging exchanges in order to determine the final price and availability. The number of exchanges is only limited by the minimal messages required to completely specify the items to be purchased. In this case, if a one way airfare is desired, the second portion can be omitted. This would be indicated by only specifying an outbound date, leaving off a return date.

What is claimed is:

1. A method whereby an offer for sale is made using a text/SMS message to a potential customer. The customer can purchase this item based on a registered form of payment and receive a confirmation that their purchase was successful.

2. The system of claim 1 where the customer is allowed to interact with additional messages in order to refine the particular item being offered. For instance, dates, quantities, etc.

3. The system of claim 1 or 2 where help is available to the customer using the same messaging system.

4. The system of claim 1 or 2 whereby the customer can receive the initial offer and respond using social media applications, such as Twitter, that utilize SMS/text messages.

5. A method whereby an offer for sale is made using a text/SMS message to a potential customer. The customer can reserve this item and render payment at the time of service and receive a confirmation that their request was successful.

6. The system of claim 5 where the customer is allowed to interact with additional messages in order to refine the particular item being offered. For instance, dates, quantities, etc.

7. The system of claim 5 or 6 where help is available to the customer using the same messaging system.

8. The system of claim 5 or 6 whereby the customer can receive the initial offer and respond using social media applications, such as Twitter, that utilize SMS/text messages.

9. The system of claim 5 or 6 whereby the system returns instructions for rendering payment when a payment is required and there is no registered form of payment.
